(19) United States
(12) Patent Application Publication
(10) Pub. No.: US 2014/0035353 A1
(43) Pub. Date: Feb. 6, 2014

(54) VEHICLE BRAKE SYSTEM

(71) Applicants: Rainer BRUEGGEMANN, Ludwigsburg (DE); Philipp FRUEH, Clayton (AU)

(72) Inventors: Rainer BRUEGGEMANN, Ludwigsburg (DE); Philipp FRUEH, Clayton (AU)

(73) Assignee: ROBERT BOSCH GMBH, Stuttgart (DE)

(21) Appl. No.: 14/050,717

(22) Filed: Oct. 10, 2013

Related U.S. Application Data
(62) Division of application No. 13/046,043, filed on Mar. 11, 2011.

(30) Foreign Application Priority Data
Mar. 25, 2010 (DE) 10 2010 003 237.9

(51) Int. Cl. B60T 11/24

(52) U.S. Cl. CPC B60T 11/24
USPC 303/6.01

(57) ABSTRACT

A vehicle brake system has a plurality of hydraulic brake circuits via which wheel brake units are supplied with brake pressure. At least one wheel brake unit is connected to at least two brake circuits and supplied with brake pressure via these two brake circuits.

### FIELD OF THE INVENTION

The present invention relates to a vehicle brake system having a plurality of hydraulic brake circuits.

### BACKGROUND INFORMATION

A hydraulic vehicle brake system which is designed as a dual-circuit brake system having two brake circuits connected to a shared main brake cylinder is described in German Patent No. DE 10 2007 020 503. Each brake circuit acts upon two wheel brake units on the vehicle wheels via adjustable valves. The vehicle brake system has a hydraulic pump unit which includes one pump for each brake circuit and a shared electric drive motor which operates both pumps. Driver assistance systems, for example a vehicle dynamics control system or an electronic stability program, may be supported via the hydraulic pump unit.

In commercial vehicles, in particular, vehicle brake systems of this type may require high pressure buildup gradients to successfully intervene in the vehicle dynamics control system. Increased pressure buildup gradients of this type may be achieved by a correspondingly greater dimensioning of the components used in the vehicle brake system, which, however, has the disadvantage that standard systems may not be used, resulting in higher costs.

### SUMMARY OF THE INVENTION

An object of the present invention is to use simple means to design a vehicle brake system having a plurality of hydraulic brake circuits in such a way that high pressure buildup gradients may be provided.

The vehicle brake system according to the present invention may be used in motor vehicles or commercial vehicles and is equipped with a plurality of hydraulic brake circuits via which the vehicle brake units are supplied with brake pressure. At least one controllable pump device is assigned to the brake circuits for the purpose of modulating the brake pressure, which makes it possible, in particular, to amplify the brake force or regulate the vehicle dynamics or implement an electronic stability program (ESP). The pump device includes at least one hydraulic pump which is preferably driven via an electric pump motor. In particular, it is provided that a hydraulic pump is assigned to each brake circuit, it being possible, if necessary, for a shared electric pump motor to drive multiple hydraulic pumps.

To be able to provide high pressure buildup gradients, at least one wheel brake unit on a vehicle wheel is connected to at least two brake circuits and supplied with brake pressure via these two brake circuits. Due to this doubling, it is possible, in principle, to provide twice as high a buildup gradient in the wheel brake unit concerned, using the same component sizes. This enables standard brake circuit devices to be used, so that it is not necessary to use components of larger dimensions, for example higher-capacity valves or pumps and pump motors. Standard structural units may be used, which results in significant cost advantages.

With the aid of the higher pressure buildup gradient, improved functions may be implemented, in particular for the purpose of vehicle stabilization or control. The high pressure buildup gradient also permits use in commercial vehicles.

According to a suitable refinement, a total of four brake circuits are provided, one wheel brake unit out of four wheel brake units in the vehicle—one wheel brake unit for each vehicle wheel—being connected to two brake circuits.

The brake circuits are suitably combined into brake circuit devices, one brake circuit device including, in particular, two brake circuits. Within a brake circuit device, one pump is preferably provided for each brake circuit, the pumps being suitably driven via a shared pump motor within a brake circuit device.

According to a further suitable embodiment, it is provided that at least one wheel brake unit is connected to two brake circuits of a shared brake circuit device. This embodiment is combined, in particular, with a further variant, in which the wheel brake units of a shared vehicle axle are provided with brake pressure via brake circuits of the same brake circuit device. The brake circuit device which includes two brake circuits is thus responsible for the two wheel brake units of a vehicle axle.

According to a further embodiment, it is provided that at least one wheel brake unit is connected to two brake circuits of two different brake circuit devices. This embodiment may be combined with the variant in which the wheel brake units on one vehicle axle are supplied with brake pressure via brake circuits of different brake circuit devices. This embodiment has the advantage that each of the four wheel brake units may be supplied with brake pressure even if a brake circuit device fails.

### BRIEF DESCRIPTION OF THE DRAWINGS

FIG. 1 shows a hydraulic circuit diagram of a vehicle brake system having two brake circuit devices, each of which has two brake circuits, a shared electric pump motor being provided in each brake circuit device for two pumps assigned to the brake circuits, and having wheel brake units, each of which is supplied with brake pressure via two brake circuits of a shared brake circuit device.

FIG. 2 shows a hydraulic circuit diagram of a further vehicle brake system which also includes two brake circuit devices, each having two brake circuits, the wheel brake units being supplied with brake pressure via brake circuits of different brake circuit devices.

### DETAILED DESCRIPTION

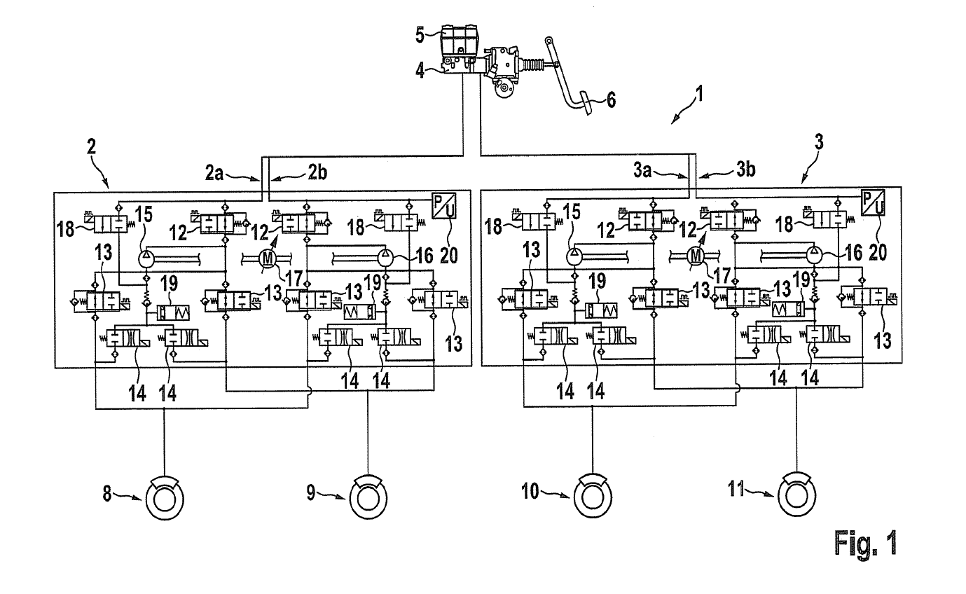

The hydraulic brake system in a brake installation 1 illustrated in FIG. 1 includes a first brake circuit device 2 and a second brake circuit device 3, each of which is provided with two brake circuits 2a, 2b and 3a, 3b for supplying wheel brake units 8 (left rear wheel), 9 (right rear wheel), 10 (left front wheel) and 11 (right front wheel). The two brake circuit devices 2 and 3, including their brake circuits 2a, 2b and 3a, 3b, are connected to a shared main brake cylinder 4, which is supplied with brake fluid via a brake fluid reservoir 5. Main brake cylinder 4 is operated by the driver via the brake pedal 6. If necessary, the pedal travel of the brake pedal is measured via an assigned pedal travel sensor.

Brake circuit device 2 is assigned to wheel brake units 8 and 9 on the vehicle's rear axle, while brake circuit device 3 is assigned to wheel brake units 10 and 11 on the vehicle's front axle. Brake circuit devices 2 and 3 have an identical design, so that only the functionality of brake circuit device 2 is described below; however, this description applies in the same manner to the other brake circuit device 3.

A switchover valve 12 is located in each brake circuit 2a, 2b of brake circuit device 2 (or in each brake circuit 3a, 3b in brake circuit device 3), the switchover valve being in the flow path between main brake cylinder 4 and particular wheel brake units 8 and 9 (or wheel brake units 10 and 11 in the case of second brake circuit device 3). Switchover valves 12 are designed as normally open valves. Each switchover valve has a parallel-connected check valve, which permits flow in the direction of the particular wheel brake unit but prevents flow in the opposite direction.

Inlet valves 13, which are also designed as normally open valves and to which check valves are assigned, are located between switchover valves 12 and the particular wheel brake units 8, 9 and 10, 11, the check valves permitting flow in the opposite direction, i.e., from the wheel brake units in the direction of main brake cylinder 4.

Each wheel brake unit 8, 9 and 10, 11 is assigned a discharge valve 14, which is designed as a normally closed valve. Discharge valves 14 are each connected to the suction side of a pump 15 and 16, both pumps 15, 16 being driven via a shared electric pump motor 17. Pump motor 17 is coupled to the two pumps 15 and 16 via a shaft. The pressure side of pumps 15 and 16 is connected to a line section between switchover valve 12 and the two inlet valves 13.

The suction sides of pumps 15 and 16 are each connected to a high-pressure switching valve 18, which is hydraulically connected to main brake cylinder 4. In a vehicle dynamics control or stabilization intervention, high-pressure switching valves 18, which are closed in the de-energized state, may be opened for rapid pressure buildup, and switchover valves 12 may be closed, so that pumps 15 and 16 draw in hydraulic fluid from main brake cylinder 4. This brake pressure buildup may be carried out independently of operation of the brake system by the driver. The two pumps 15 and 16, together with shared pump motor 17, belong to a driver assistance system and form, in particular, a component of an electronic stability program (ESP).

In each brake circuit 2a, 2b and 3a, 3b, a hydraulic accumulator 19 is located between discharge valves 14 and the suction side of pumps 15 and 16, the hydraulic accumulator being used to temporarily store brake fluid which is discharged from wheel brake units 8, 9 and 10, 11, through discharge valves 14 during a vehicle dynamic control intervention. A check valve, which opens in the direction of the suction sides of pumps 15, 16, is assigned to each hydraulic accumulator 19.

A pressure sensor 20, which is situated adjacent to main brake cylinder 4, is located in brake circuit 2b and 3b, if necessary, for the purpose of measuring pressure. The brake pressure in entire brake circuit device 2 and 3 is measured via pressure sensor 20, since particular brake circuits 2a, 2b and 3a, 3b are hydraulically connected to each other.

In the brake system according to FIG. 1, each wheel brake unit 8, 9, 10, 11 is connected to two brake circuits 2a, 2b, 3a, 3b. Wheel brake unit 8 assigned to the left rear wheel is connected to the two brake circuits 2a and 2b, and the same applies to wheel brake unit 9 assigned to the right rear wheel of the vehicle. However, each of the two wheel brake units 8 and 9 is coupled to the two brake circuits 2a, 2b via different inlet valves 13.

Similarly, wheel brake units 10 (on the left front vehicle wheel) and 11 (on the right front vehicle wheel) are each connected to two brake circuits 3a and 3b of second brake circuit device 3.

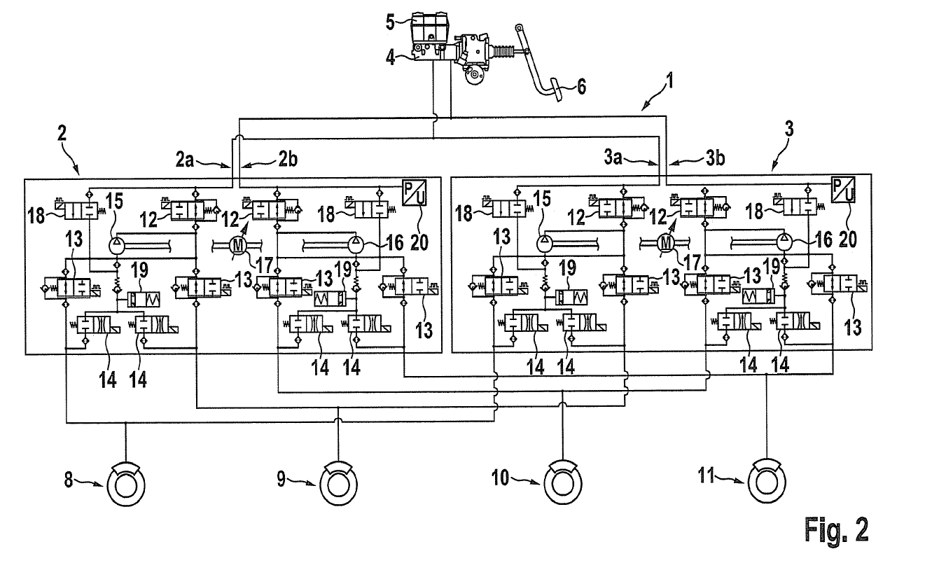

FIG. 2 shows a further hydraulic circuit diagram of a brake system 1, which also has two identical brake circuit devices 2 and 3 which are independent of each other. The design of these brake circuit devices 2 and 3 is identical to that of the brake circuit devices in FIG. 1, so that reference is hereby made to the description in FIG. 1 with regard to their mode of operation.

In contrast to the first exemplary embodiment, however, wheel brake units 8 through 11 are alternatively coupled to brake circuits 2a, 2b and 3a, 3b. Wheel brake unit 8 (left rear) is connected to brake circuits 2a and 3a of brake circuit devices 2 and 3. Wheel brake unit 9 (right rear) is also connected to brake circuits 2a and 3a of brake circuit devices 2 and 3, however via different inlet valves 13 than in wheel brake unit 8.

Wheel brake unit 10 (left front) is connected to brake circuits 2b and 3b of brake circuit devices 2 and 3. Wheel brake unit 11 (right front) is also connected to brake circuits 2b and 3b of brake circuit devices 2 and 3, however, in a manner similar to wheel brake units 8 and 9, using different inlet valves 13 of the particular brake circuits.

In the exemplary embodiment according to FIG. 1 as well as in the exemplary embodiment according to FIG. 2, each wheel brake unit 8, 9, 10, 11 is supplied with brake pressure via two brake circuits. In addition to a more reliable supply in the event of a failure of one structural unit in the brake system, this enables higher pressure buildup gradients, in particular those which are twice as high as in an embodiment in which the brake pressure is applied to the wheel brake units via only one brake circuit.

1. A vehicle brake system comprising:
a plurality of hydraulic brake circuits, via which wheel brake units are supplied with brake pressure; and
a controllable pump device assigned to the brake circuits,
wherein each of at least one wheel brake unit is connected to at least two brake circuits of two different brake circuit devices and supplied with brake pressure via the at least two brake circuits.

2-6. (canceled)

7. The vehicle brake system according to claim 1, wherein wheel brake units on one vehicle axle are supplied with brake pressure via brake circuits of different brake circuit devices.

8-10. (canceled)
